(19) United States
(12) Patent Application Publication
(10) Pub. No.: US 2021/0116102 A1
(43) Pub. Date: Apr. 22, 2021

(54) SELECTABLE LIGHTING INTENSITY AND COLOR TEMPERATURE USING LUMINAIRE LENS

(71) Applicant: ABL IP Holding LLC, Atlanta, GA (US)

(72) Inventor: Yan Rodriguez, Suwanee, GA (US)

(21) Appl. No.: 17/071,108

(22) Filed: Oct. 15, 2020

Related U.S. Application Data
(60) Provisional application No. 62/916,422, filed on Oct. 17, 2019.

(51) Int. Cl. F21V 9/40; F21S 10/02; H05B 47/10

(52) U.S. Cl. CPC F21V 9/40; H05B 47/10; F21S 10/026

(57) ABSTRACT

A lighting system includes a lighting device within a luminaire that generates a controllable light output. The lighting system also includes an input device within the luminaire. The input device includes a first selection mechanism communicatively coupled to the lighting device. The first selection mechanism receives a first input to transition the lighting system between a set of control states. The input device also includes a second selection mechanism communicatively coupled to the lighting device. The second selection mechanism receives a first rotational input to control a light intensity output of the lighting device or a correlated color temperature of the lighting device.

### CROSS-REFERENCE TO RELATED APPLICATION

This claims the benefit to U.S. Provisional Application No. 62/916,422 filed on Oct. 17, 2019, titled “SELECTABLE LIGHTING INTENSITY AND COLOR TEMPERATURE USING LUMINAIRE LENS,” the disclosure of which is hereby incorporated by reference in its entirety for all purposes.

### TECHNICAL FIELD

Embodiments of the presently disclosed subject matter relate to light fixtures with selectable lighting intensity and color temperature outputs. In particular, the presently disclosed subject matter relates to a luminaire that selects lighting intensity, color temperature, or both using mechanical input from a lens of the luminaire.

### BACKGROUND

Control of a luminaire is often provided using switches, chains, slider bars, or other actuating mechanisms that are located on an external surface of the luminaire. When providing selection mechanisms capable of controlling multiple light features (e.g., on/off, light intensity, correlated color temperature (CCT), etc.), external surfaces of the luminaire may become cluttered with the selection mechanisms. Other luminaires provide selection mechanisms in “hidden” locations when the luminaire is installed. Such an arrangement prevents the ability to adjust light features after the luminaire has been installed (e.g., for a downlight or a ceiling mounted light). To avoid external surface clutter, to increase usability, and to enable light output adjustments after the luminaire is installed, alternative selection mechanisms for the luminaire are desired.

### SUMMARY

Certain aspects involve lighting control systems that enable control of luminaire operations. For instance, a lighting system includes a lighting device within a luminaire that generates a controllable light output. The lighting system also includes an input device within the luminaire. The input device includes a first selection mechanism communicatively coupled to the lighting device. The first selection mechanism receives a first input to transition the lighting system between a set of control states. The input device also includes a second selection mechanism communicatively coupled to the lighting device. The second selection mechanism receives a first rotational input to control a light intensity output of the lighting device or a correlated color temperature of the lighting device.

In an additional example, an input device includes a first selection mechanism positionable within a luminaire to communicatively couple to a lighting device of the luminaire. The first selection mechanism receives a first input to transition the lighting device from a first control state to a second control state. Additionally, the input device includes a second selection mechanism positionable within the luminaire to communicatively couple to the lighting device of the luminaire. The second selection mechanism receives a first rotational input to control a light intensity output of the lighting device or a correlated color temperature of the lighting device associated with the second control state.

In an additional example, a method includes receiving a first input from a first selection mechanism at a luminaire of a lighting system to transition from a first lighting control state to a second lighting control state. The method also includes receiving a second input from a rotational input mechanism at a luminaire of the lighting system to adjust a light output of the lighting system in the second lighting control state. Further, the method includes controlling a light intensity output or a correlated color temperature output of the lighting system using the second input from the rotational input mechanism.

These illustrative aspects are mentioned not to limit or define the disclosure, but to provide examples to aid understanding thereof. Additional aspects are discussed in the Detailed Description, and further description is provided there.

### BRIEF DESCRIPTION OF THE DRAWINGS

Features, aspects, and advantages of the present disclosure are better understood when the following Detailed Description is read with reference to the accompanying drawings.

FIG. 1 depicts a sectional schematic view of a luminaire including a lens diffuser selection mechanism, according to certain aspects of the present disclosure.

FIG. 2 depicts a schematic view of a room facing (e.g., downward facing) portion of the luminaire of FIG. 1, according to certain aspects of the present disclosure.

FIG. 3 depicts a sectional schematic view of a luminaire that extends below a ceiling and includes a lens diffuser selection mechanism, according to certain aspects of the present disclosure.

FIG. 4 depicts a flowchart of a process for controlling the luminaires of FIGS. 1 and 3 using a lens diffuser selection mechanism, according to certain aspects of the present disclosure.

FIG. 5 depicts an example of state diagram of the luminaires of FIGS. 1 and 3, according to certain aspects of the present disclosure.

### DETAILED DESCRIPTION

The present disclosure relates to systems that that enable control of luminaire operations using interactive user interfaces. As explained above, devices currently used to control certain types of connected lighting systems may suffer from accessibility issues. As a result, access to control of the connected lighting system may be limited.

The subject matter of the presently disclosed embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The presently disclosed subject matter includes a luminaire with an internal light output selection mechanism. For example, the luminaire may include a mechanism capable of selecting a correlated color temperature (CCT), a light intensity, an “on” or “off” state, or a combination thereof using a depression of a lens diffuser of the luminaire, using a rotation of a portion of the luminaire, or using a combination of lens diffuser depression and rotation. For example, upon depressing a lens diffuser of a luminaire, the luminaire may enter an “on” state (e.g., generating light output) from an “off” state (e.g., not generating light output) or an “off” state from an “on” state. In another example, depressing the lens diffuser may change a light intensity output of the luminaire, or depressing the lens diffuser may change a CCT of the light output of the luminaire.

In another example, the light intensity, the CCT, or both of the luminaire may be adjusted by rotating the lens diffuser in a clockwise or counterclockwise direction. For example, the lens diffuser may rotate freely within a lens housing, and a rotation tracker may adjust the light intensity or CCT based on a detection of how much the lens diffuser has rotated. In an additional example, a cone reflector (e.g., within a downlight) may also be rotatable to control output of the light intensity or the CCT of the luminaire.

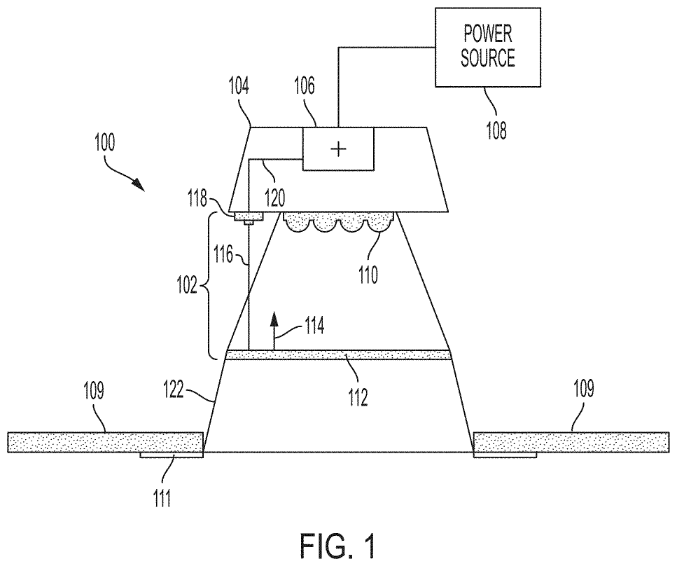

FIG. 1 is a sectional schematic view of a luminaire 100 including a lens diffuser selection mechanism 102. The luminaire 100 includes a housing 104 with a controller 106. The controller 106 may be coupled to an external or internal power source 108, and the controller 106 provides control signals to one or more lighting devices 110 (e.g., light emitting diodes or other light sources). The luminaire 100 may be installed within a ceiling 109, and a flange 111 of the luminaire 100 may be positioned flush with the ceiling 109 such that gaps are avoided between the luminaire 100 and a hole in the ceiling 109 in which the luminaire 100 is positioned.

In an example, the controller 106 controls the light intensity and the CCT of the lighting devices 110 based on a user interaction with the lens diffuser selection mechanism 102. The lens diffuser selection mechanism 102 may include a lens diffuser 112 that diffuses light from the lighting devices 110. In an example, a user may depress a lens diffuser 112 toward the lighting devices 110. Depression of the lens diffuser 112 exerts a force in a direction 114 on a selection rod 116 or other actuation device. The selection rod 116 may depress or otherwise interact with a switching mechanism 118. Based on the interaction between the selection rod 116 and the switching mechanism 118, a control signal is provided along a control line 120 to the controller 106 to control the light output of the lighting devices 110. Other components of the luminaire 100 may also be used to provide the force in the direction 114 on the selection rod 116. For example, a cone reflector 122 may be depressed to interact with a selection rod 116 of the switching mechanism 118.

As discussed above, the depression of the lens diffuser 112 may cause the controller 106 to control the lighting devices 110 in several different ways. For example, each depression of the lens diffuser 112 may result in the transition of the lighting devices 110 from an “off” state to an “on” state or from an “on” state to an “off” state. In another example, each depression of the lens diffuser 112 may cycle through available light intensities for the lighting devices 110. For example, a first depression of the lens diffuser 112 may provide an output light intensity of 100%, a second depression of the lens diffuser 112 may provide an output light intensity of 75%, a third depression of the lens diffuser 112 may provide an output light intensity of 50%, and so on. Other transitions between output light intensities are also contemplated. In another example, each depression of the lens diffuser 112 may cycle through available CCTs of the lighting devices 110. For example, a first depression of the lens diffuser 112 may provide an output CCT that appears “warm,” while a second depression of the lens diffuser 112 may transition the output CCT to appear “cool.” Other output CCT transitions are also contemplated.

In another example, the depression of the lens diffuser 112 may send a control signal along the control line 120 to the controller 106 to transition the control mode of the lighting devices 110. For example, a first depression of the lens diffuser 112 may transition the lighting devices 110 to an “on” state from an “off” state. A second depression of the lens diffuser 112 may transition the lighting devices 110 into a light intensity control mode. While the lighting devices 110 are in a light intensity control mode, the lens diffuser 112 may be rotated (e.g., clockwise or counterclockwise) to provide control signals to the controller 106 that control the light intensity of the lighting devices 110. For example, as the lens diffuser 112 rotates in a clockwise direction, the light intensity of the lighting devices 110 may increase. Similarly, as the lens diffuser 112 rotates in a counterclockwise direction, the light intensity of the lighting devices 110 may decrease.

A third depression of the lens diffuser 112 may transition the lighting devices 110 into a CCT control mode. While the lighting devices 110 are in the CCT control mode, the lens diffuser 112 may be rotated to provide control signals to the controller 106 to control the CCT output by the lighting devices 110. For example, as the lens diffuser 112 rotates in a clockwise direction, the CCT may gradually transition from a warmer color temperature to a colder color temperature. Similarly, as the lens diffuser 112 rotates in a counterclockwise direction, the CCT may gradually transition from a cooler color temperature to a warmer color temperature. Further, a fourth depression of the lens diffuser 112 may transition the lighting devices 110 from the “on” state to the “off” state.

The lighting devices 110 may also be controlled by depressing the lens diffuser 112 in different manners. For example, depressing the lens diffuser 112 with a “long” press (e.g., where the lens diffuser 112 is depressed for more than 1 second) may transition the lighting devices into one control mode (e.g., a CCT control mode or a light intensity control mode). Additionally, depressing the lens diffuser 112 with a “short” press (e.g., where the lens diffuser 112 is depressed for less than or equal to 1 second) may transition the lighting devices into the other control mode. Further, a series of “long” presses may control the lighting devices 110 in a manner different from a series of “short” presses. For example, three “long” presses may cycle through color temperature settings, while three “short” presses may cycle through light intensity settings. In another example, combinations of “long” and “short” presses may change the control mode of the lighting devices 110. For example, each control mode may be accessed by a unique combination of the “long” and “short” presses on the lens diffuser 112.

In another example, the rotational control of the lighting devices 110 may be provided by rotating a cone reflector 122 of the luminaire 100. For example, the cone reflector 122 may be rotated in place of the lens diffuser 112 or in addition to the lens diffuser 112. For example, upon depressing the lens diffuser 112 to transition the lighting devices 110 from the “off” state to the “on” state, the lens diffuser 112 may be rotated to control the light intensity of the lighting devices 110, while the cone reflector 122 may be rotated to control the CCT of the lighting devices 110. In another example, the lens diffuser 112 is rotated to control the CCT of the lighting devices 110, while the cone reflector 112 is rotated to control the light intensity of the lighting devices 110. Any other characteristics of the lighting devices 110 may also be controlled by the depression of the lens diffuser 112, rotation of the lens diffuser 112 or other component of the luminaire 100, or any combination thereof.

In another example, the depression of the lens diffuser 112 may cycle through light intensities of the lighting devices 110, while rotation of the lens diffuser 112 or the cone reflector 122 provides control of the CCT of the lighting devices 110. Similarly, the depression of the lens diffuser 112 may cycle through CCT settings of the lighting devices 110, while the rotation of the lens diffuser 112 provides control of the light intensity of the lighting devices 110.

While the rotational control is generally described herein as being provided by rotational movement of the lens diffuser 112 or cone reflector 122, other components of the luminaire 100 may also be rotated to control the output of the lighting devices 110. For example, the flange 111 may also be rotated to provide control of CCT, light intensity, or both of the lighting devices 110. Further, other control mechanisms may be incorporated into the luminaire 100. For example, a sliding bar may be installed within the luminaire 100 to provide control of one or more of the lighting characteristics of the lighting devices 110. In an example of a linear luminaire, the lens diffuser 112 may provide a sliding movement in place of the rotational movement of the lens diffuser 112 described above.

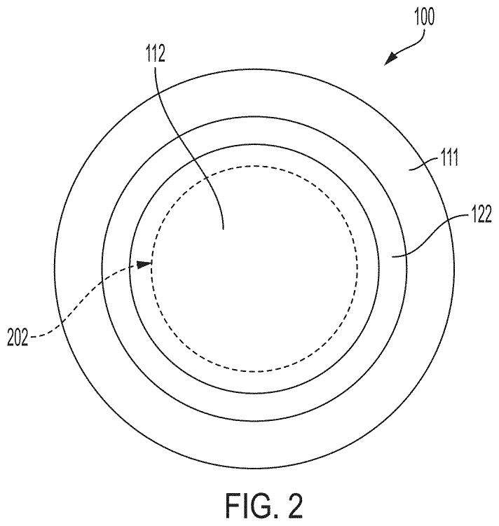

FIG. 2 is a schematic view of a room facing (e.g., downward facing) portion of the luminaire 100. As discussed above with respect to FIG. 1, any of the flange 111, the cone reflector 122, and the lens diffuser 112 can be rotated to control the CCT and light intensity of the lighting devices 110. Additionally, the luminaire 100 may include a bezel 202 that is rotatable around the lens diffuser 112. The bezel 202 may rotate about the lens diffuser 112 to control characteristics of the lighting devices 110 while the lens diffuser 112 remains stationary. Other lighting control mechanisms may also be installed with the luminaire 100 to control lighting characteristics of the lighting devices 110.

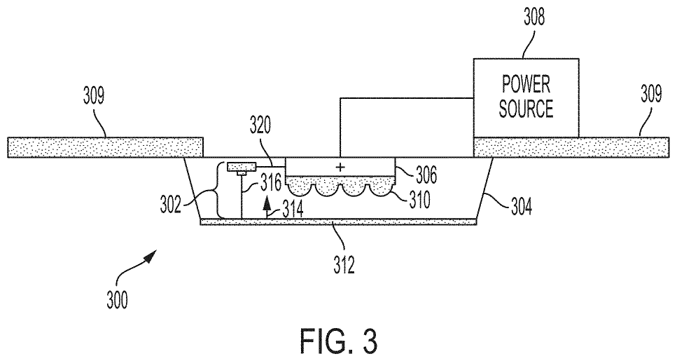

FIG. 3 is a sectional schematic view of a luminaire 300 that extends below a ceiling 309 and includes a lens diffuser selection mechanism 302. The luminaire 300 includes a housing 304 with a controller 306. The controller 306 may be coupled to an external or internal power source 308, and the controller 306 provides control signals to one or more lighting devices 310 (e.g., light emitting diodes or other light sources). The luminaire 300 may be installed within the ceiling 309.

In an example, the controller 306 controls the light intensity and the CCT of the lighting devices 310 based on a user interaction with the lens diffuser selection mechanism 302. For example, a user may depress a lens diffuser 312 toward the lighting devices 310. Depression of the lens diffuser 312 exerts a force in a direction 314 on a selection rod 316 or other actuation device. The selection rod 316 depresses or otherwise interacts with a switching mechanism 318. Based on the interaction between the selection rod 316 and the switching mechanism 318, a control signal is provided along a control line 320 to the controller 306 to control the light output of the lighting devices 310.

As discussed above, the depression of the lens diffuser 312 may cause the controller 306 to control the lighting devices 310 in several different ways. For example, each depression of the lens diffuser 312 may result in the transition of the lighting devices 310 from an “off” state to an “on” state or from an “on” state to an “off” state. In another example, each depression of the lens diffuser 312 may cycle through available light intensities for the lighting devices 310. For example, a first depression of the lens diffuser 312 may provide an output light intensity of 100%, a second depression of the lens diffuser 312 may provide an output light intensity of 75%, a third depression of the lens diffuser 312 may provide an output light intensity of 50%, and so on. Other transitions between output light intensities are also contemplated.

In another example, each depression of the lens diffuser 312 may cycle through available CCTs of the lighting devices 310. For example, a first depression of the lens diffuser 312 may provide an output CCT that appears “warm,” while a second depression of the lens diffuser 312 may transition the output CCT to appear “cool.” Other output CCT transitions are also contemplated.

In another example, the depression of the lens diffuser 312 may send a control signal along the control line 320 to the controller 306 to transition the control mode of the lighting devices 310. For example, a first depression of the lens diffuser 312 may transition the lighting devices 310 to an “on” state from an “off” state. A second depression of the lens diffuser 312 may transition the lighting devices 310 into a light intensity control mode. While the lighting devices 310 are in the light intensity control mode, the lens diffuser 312 may be rotated to provide control signals to the controller 306 to control the light intensity of the lighting devices 310. For example, as the lens diffuser 312 rotates in a clockwise direction, the light intensity of the lighting devices 310 may increase. Similarly, as the lens diffuser 312 rotates in a counterclockwise direction, the light intensity of the lighting devices 310 may decrease.

A third depression of the lens diffuser 312 may transition the lighting devices 310 into a CCT control mode. While the lighting devices 310 are in the CCT control mode, the lens diffuser 312 may be rotated to provide control signals to the controller 306 to control the CCT output by the lighting devices 310. For example, as the lens diffuser 312 rotates in a clockwise direction, the CCT may gradually transition from a warmer color temperature to a colder color temperature. Similarly, as the lens diffuser 312 rotates in a counterclockwise direction, the CCT may gradually transition from a colder color temperature to a warmer color temperature. Further, a fourth depression of the lens diffuser 312 may transition the lighting devices 310 from the “on” state to the “off” state.

In another example, the rotational control of the lighting devices 310 may be provided by rotating the housing 304 of the luminaire 100. For example, the housing 304 may be rotated in place of the lens diffuser 312 or in addition to the lens diffuser 312. In an example, upon depressing the lens diffuser 312 to transition the lighting devices 310 from the “off” state to the “on” state, the lens diffuser 312 may be rotated to control the light intensity of the lighting devices 310, while the housing 304 may be rotated to control the CCT of the lighting devices 310. In another example, the lens diffuser 312 is rotated to control the CCT of the lighting devices 310, while the housing 304 is rotated to control the light intensity of the lighting devices 310.

In other examples, the depression of the lens diffuser 312 may cycle through light intensities of the lighting devices 310, while rotation of the lens diffuser 312 or the housing 304 provides control of the CCT of the lighting devices 310. Similarly, the depression of the lens diffuser 312 may cycle through CCT settings of the lighting devices 310, while the rotation of the lens diffuser 312 provides control of the light intensity of the lighting devices 310.

While the rotational control is generally described herein as being provided by rotational movement of the lens diffuser 312 or the housing 304, other components of the luminaire 300 may also be rotated to control the output of the lighting devices 310. For example, other control mechanisms may also be incorporated into the luminaire 300 such as a diffuser lens bezel or other rotating component capable of providing control for one or more of the lighting characteristics of the lighting devices 310.

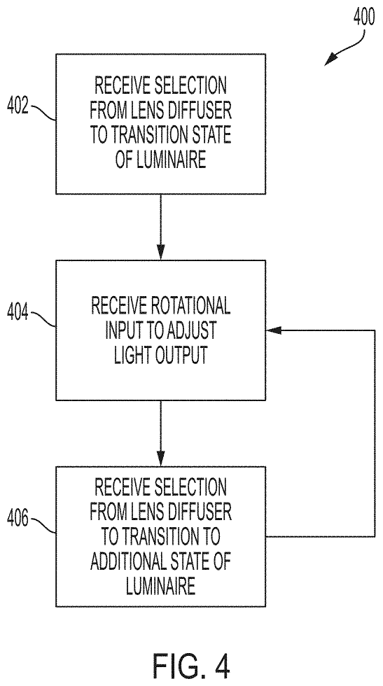

FIG. 4 is a flowchart of a process 400 for controlling the luminaire 100 using a lens diffuser selection mechanism 102. While the process 400 is described with respect to the luminaire 100 depicted in FIG. 1, the process 400 may also apply to the luminaire 300 depicted in FIG. 3. At block 402, the process 400 involves receiving a selection from the lens diffuser 112 to transition a state of the luminaire. In some examples, the selection may involve a user depressing the lens diffuser 112 to transition the state of the luminaire to a correlated color temperature (CCT) control state, a light intensity control state, an “on” or “off” state, or a combination thereof.

At block 404, the process 400 involves receiving a rotational input at the luminaire 100 to adjust the lumen output or the CCT output of the luminaire 100. The rotational input may be provided by rotation of the lens diffuser 112 or any other rotational elements of the luminaire 100, as described above with respect to FIGS. 1-3. In another example, the lens diffuser 112 may be rotated to control the CCT output of the luminaire 100, while an additional rotational element of the luminaire 100 (e.g., the cone reflector 122, the bezel 202, the flange 111, the housing 304, etc.) is rotated to control the light intensity of the luminaire 100. Moreover, any combination rotational elements of the luminaire 100 may be used for controlling the CCT output and the light intensity of the luminaire 100.

At block 406, the process 400 involves receiving a selection from the lens diffuser 112 to transition the luminaire 100 to an additional state of the luminaire 100. In an example, the luminaire 100 may transition from the CCT control state to the light intensity control state. In such an example, the process 400 may return to block 404 to receive another rotational input at the luminaire 100 to control the light intensity of the luminaire 100. In an additional example, the luminaire 100 may transition to the “off” state upon receiving the selection at block 406.

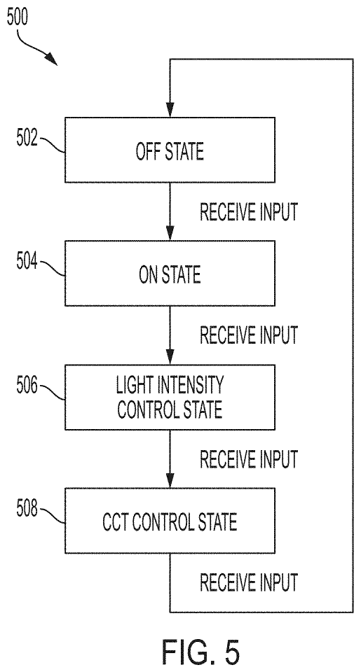

FIG. 5 depicts an example of state diagram 500 of the luminaires 100 and 300, according to certain aspects of the present disclosure. While the state diagram 500 depicts an OFF state 502 as an initial state, any of the described states may be the initial state of the luminaires 100 and 300. Further, the states depicted in the state diagram 500 may occur in any order. As shown, the OFF state 502 may be when the luminaires 100 and 300 are not generating a light output. After receiving an input from the lens diffuser selection mechanism 102, the luminaires 100 and 300 may transition to an ON state 504. The ON state 504 may be when the luminaires 100 and 300 output a light. The light output when transitioning to the ON state 504 may be a pre-determined light output (e.g., a pre-determined light intensity and CCT), or the light output may be a most recent light output prior to the luminaires 100 and 300 entering the OFF state 502.

Upon receiving another input from the lens diffuser selection mechanism 102, the luminaires 100 and 300 may transition to a light intensity control state 506. In the light intensity control state 506, the luminaires 100 and 300 may receive a rotational input from a rotational element of the luminaires 100 and 300 to control the light intensity of the light output from the luminaires 100 and 300. The rotational input in a clockwise direction may increase the light intensity, while the rotational input in the counterclockwise direction may decrease the light intensity of the luminaires 100 and 300.

Upon receiving another input from the lens diffuser selection mechanism 102, the luminaires 100 and 300 may transition to a correlated color temperature (CCT) control state 508. In the CCT control state 508, the luminaires 100 and 300 may receive a rotational input from a rotational element of the luminaires 100 and 300 to control the color temperature of the light output from the luminaires 100 and 300. The rotational input in a clockwise direction may increase the coolness of the color temperature of the light output, while the rotational input in the counterclockwise direction may increase a warmth of the color temperature of the light output of the luminaires 100 and 300. Upon receiving another input from the lens diffuser selection mechanism 102, the luminaires 100 and 300 may transition to the OFF state 502.

In an example, the transition from the OFF state 502 to the ON state 504 may transition the luminaires 100 and 300 directly to the light intensity control state 506 or the CCT control state 508 without an additional input after transitioning to the ON state 504. Further, the transitions to the light intensity control state 506 and the CCT control state 508 may occur simultaneously when the luminaires 100 and 300 have multiple rotational elements that can receive a rotational input. For example, the lens diffuser 112 can receive a rotational input to control the light intensity while the cone reflector 122 can receive a rotational input to control the CCT of the light output. That is, one rotational element may be assigned to light intensity control while another rotational element may be assigned to CCT control of the luminaires 100 and 300.

The foregoing is provided for purposes of illustrating, explaining, and describing various embodiments. Having described these embodiments, it will be recognized by those of skill in the art that various modifications, alternative constructions, and equivalents may be used without departing from the spirit of what is disclosed. Different arrangements of the components depicted in the drawings or described above, as well as additional components and steps not shown or described, are possible. Certain features and subcombinations of features disclosed herein are useful and may be employed without reference to other features and subcombinations. Additionally, a number of well-known processes and elements have not been described in order to avoid unnecessarily obscuring the embodiments. Embodiments have been described for illustrative and not restrictive purposes, and alternative embodiments will become apparent to readers of this patent. Accordingly, embodiments are not limited to those described above or depicted in the drawings, and various modifications can be made without departing from the scope of the presently disclosed subject matter.

What is claimed is:

1. A lighting system, comprising:
a lighting device within a luminaire configured to generate a controllable light output; and
an input device within the luminaire, comprising:
a first selection mechanism communicatively coupled to the lighting device, wherein the first selection mechanism is configured to receive a first input to transition the lighting system between a set of control states; and
a second selection mechanism communicatively coupled to the lighting device, wherein the second selection mechanism is configured to receive a first rotational input to control a light intensity output of the lighting device or a correlated color temperature of the lighting device.

2. The lighting system of claim 1, further comprising:
a lens diffuser configured to diffuse the controllable light output of the lighting device, wherein the first input comprises a depression of the lens diffuser that is detectable by the first selection mechanism.

3. The lighting system of claim 2, wherein the first rotational input comprises a rotation of the lens diffuser that is detectable by the second selection mechanism.

4. The lighting system of claim 1, wherein the first selection mechanism is further configured to receive a second input to transition the lighting system to an additional control state of the set of control states, and wherein the second selection mechanism is further configured to receive a second rotational input to control the light intensity output of the lighting device or the correlated color temperature of the lighting device associated with the additional control state.

5. The lighting system of claim 1, further comprising:
a third selection mechanism communicatively coupled to the lighting device, wherein the third selection mechanism is configured to receive a second rotational input to control the light intensity output of the lighting device or the correlated color temperature of the lighting device.

6. The lighting system of claim 5, further comprising:
a lens diffuser configured to diffuse the controllable light output of the lighting device, wherein the first rotational input comprises a rotation of the lens diffuser; and
an additional rotational element, wherein the second rotational input comprises a rotation of the additional rotational element.

7. The lighting system of claim 6, wherein the additional rotational element comprises a cone reflector, a bezel, a flange, or a housing of the lighting system.

8. The lighting system of claim 1, wherein the set of control states comprises a correlated color temperature (CCT) control state, a light intensity control state, and an “on” or “off” state of the lighting system.

9. The lighting system of claim 1, further comprising:
a lens diffuser configured to transmit the first input to the first selection mechanism, wherein the first selection mechanism comprises:
a switching mechanism; and
a selection rod configured to receive the first input from the lens diffuser and to interact with the switching mechanism in response to the first input received from the lens diffuser.

10. An input device, comprising:
a first selection mechanism positionable within a luminaire and configured to communicatively couple to a lighting device of the luminaire, wherein the first selection mechanism is configured to receive a first input to transition the lighting device from a first control state to a second control state; and
a second selection mechanism positionable within the luminaire configured to communicatively couple to the lighting device of the luminaire, wherein the second selection mechanism is configured to receive a first rotational input to control a light intensity output of the lighting device or a correlated color temperature of the lighting device associated with the second control state.

11. The input device of claim 10, wherein the first rotational input is configured to control the light intensity output when the lighting device is in the first control state, and wherein the first rotational input is configured to control the correlated color temperature when the lighting device is in the second control state.

12. The input device of claim 10, wherein the first input comprises a depression of a lens diffuser of the lighting device.

13. The input device of claim 10, wherein the first rotational input comprises a rotation of a lens diffuser, a cone reflector, a bezel, a flange, or a housing of the lighting device.

14. The input device of claim 10, wherein the first selection mechanism is further configured to receive a second input to transition the lighting device to a third control state, and wherein the second selection mechanism is further configured to receive a second rotational input to control the light intensity output of the lighting device or the correlated color temperature of the lighting device that is associated with the third control state.

15. The input device of claim 10, wherein the first control state and the second control state each comprise a correlated color temperature (CCT) control state, a light intensity control state, or an “on” or “off” state of the lighting device.

16. The input device of claim 10, wherein the first selection mechanism comprises:
a switching mechanism; and
a selection rod configured to receive the first input from a lens diffuser of the lighting device and to interact with the switching mechanism in response to the first input received from the lens diffuser.

17. A method, comprising:
receiving a first input from a first selection mechanism at a luminaire of a lighting system to transition from a first lighting control state to a second lighting control state;
receiving a second input from a rotational input mechanism at a luminaire of the lighting system to adjust a light output of the lighting system in the second lighting control state; and
controlling a light intensity output or a correlated color temperature output of the lighting system using the second input from the rotational input mechanism.

18. The method of claim 17, further comprising:
receiving a third input from the first selection mechanism at the luminaire of the lighting system to transition from the second lighting control state to a third lighting control state;
receiving a fourth input from the rotational input mechanism at the luminaire of the lighting system to adjust a light output of the lighting system in the third lighting control state; and
controlling the light intensity output or the correlated color temperature output of the lighting system using the fourth input from the rotational input mechanism.

19. The method of claim 18, wherein the second input from the rotational input mechanism controls the light intensity output while maintaining the correlated color temperature output of the lighting system, and wherein the fourth input from the rotational input mechanism controls the correlated color temperature output while maintaining the light intensity output of the lighting system.

20. The method of claim 17, wherein receiving the first input from the first selection mechanism comprises detecting a depression of a lens diffuser of the lighting system, and wherein receiving the second input from the rotational input mechanism comprises detecting rotation of the lens diffuser.
